(19) United States
(12) Patent Application Publication
(10) Pub. No.: US 2015/0082760 A1
(43) Pub. Date: Mar. 26, 2015

(54) Method for operating a snapping unit having stripper plates with variable spacing

(71) Applicant: Claas Selbstfahrende Erntemaschinen Gmbh, Harsewinkel (DE)

(72) Inventor: Seth Zentner, Omaha, NE (US)

(21) Appl. No.: 14/487,366

(22) Filed: Sep. 16, 2014

(30) Foreign Application Priority Data
Sep. 23, 2013 (DE) 10 2013 110 498.3

(51) Int. Cl. A01D 45/02

(52) U.S. Cl. CPC A01D 45/021
USPC 56/62

(57) ABSTRACT

A method for operating a snapping device to harvest stalk crop relies upon stripper plates disposed in pairs and having a variable spacing therebetween. A snapping gap is formed by or in the variable spacing. Plant stalks are drawn into the snapping gap to sever crop fruit from crop stalks by the stripper plates. The diameter of the crop stalks is determined before entry into the snapping gap by a sensor device disposed in front of the snapping gap. A width of the snapping gap is adjusted depending on the diameter value that is determined.

### CROSS-REFERENCE TO A RELATED APPLICATION

The invention described and claimed hereinbelow is also described in German Patent Application DE 10 2013 110498.3, filed on Sep. 23, 2013. The German Patent Application, the subject matters of which is incorporated herein by reference, provides the basis for a claim of priority of invention under 35 U.S.C. 119(a)-(d).

### BACKGROUND OF THE INVENTION

The present invention relates to a snapping unit for use in an agricultural working machine.

Document EP 2 412 228 A1 makes known a method for operating a snapping unit. The snapping unit according to EP 2 412 228 A1 comprises stripper plates having spacing which can be varied by actuators and between which a snapping gap forms. The width of the snapping gap, i.e., the horizontal distance between the mutually opposed stripper plates, is predefined. The predefined snapping-gap width between the stripper plates is changed by moving the stripper plates away from one another or toward one another by the actuators depending on the presence of a pressure force directed by the plant stalks laterally onto the stripper plates. The actuators are activated in a diameter-dependent manner to enlarge the snapping-gap width when a predefinable value of the pressure force exerted by the crop onto the snapping plates is exceeded. After a predefinable period of time within which the predefinable value was not exceeded again, the gap width is restored to the default value.

A disadvantage of the method known from EP 2 412 228 A1 is that a change in diameter in the stand to be harvested is detected relatively late, since the change in diameter cannot be detected until the plant stalk is already located between the stripper plates. This results in a time delay in the adjustment of the snapping-gap width. As a result thereof, a snapping-gap width can be set to be too large due to a previous change in spacing between the stripper plates and thereby result in grain losses due to the lower end of the crop being drawn in by snapping rollers disposed underneath the stripper plates (so-called “butt shelling”).

### SUMMARY OF THE INVENTION

The present invention overcomes the shortcomings of known arts, such as those mentioned above.

To that end, the present invention provides a method for operating a snapping unit and a snapping device, which permit a more flexible adaptation to changing crop properties and crop conditions.

In an embodiment, the presence and the diameter of the crop stalks are determined before entry into the snapping gap by a sensor device disposed in front of the snapping gap. The width of the snapping gap is adjusted depending on the diameter value that is determined by the sensor. The fact that the diameter of a crop stalk is ascertained at an early point in time makes it possible to respond quickly to changing crop properties, i.e., in particular, to reduce crop losses resulting from snapping-gap settings that have not been adjusted. To this end, a control unit is provided on the carrier vehicle. The control unit comprises a processor unit and a memory unit for the storage of the data and algorithms that are processed by the processor unit. The control unit executes algorithms, by which the presence and the diameter of the crop stalks is determined on the basis of the evaluation of sensor signals.

Advantageously, the crop stalks are contactlessly detected. Contactless detection has the advantage over detection based on the application of pressure by the crop stalks onto the stripper plates that a measuring device for contactless detection is less complex.

Contactless detection is implemented by detecting the crop stalks by a measurement method that operates via capacitance. In this case, a signal change based on an increase in the capacitance that is measured is induced by a crop stalk entering a measuring region.

As an alternative, the crop stalks are detected by an optically operating measurement method. The duration of the interruption of a light barrier can be detected, for example.

Preferably, the crop stalks are detected by mechanical sensing elements. The deflection of the sensing elements out of a definable neutral position by the stalks that are received by the snapping gap disposed downstream of the sensing elements is detected by sensors. Potentiometers, linear sensors, or angular sensors can be provided for this purpose, which detect the deflection of the mechanical sensing elements and output a sensor signal representing the deflection.

In an embodiment, the snapping-gap is automatically varied. In general, an operator specifies a setting for the snapping-gap width before the harvesting process is started. The automatic variation implemented during the harvesting process therefore relieves an operator guiding the carrier vehicle of the task of adjusting the snapping-gap width during the harvesting process.

In particular, the number of crop stalks and the spacing therebetween is determined. The combination of counting and determining the spacing within a row of crop stalks makes it possible to inspect the quality of the sowing. In particular, it is possible to document the placement of two seed corns directly next to one another and to document the omission of the sowing of a single grain of seed corn within a row.

To this end, the diameters that are detected, the number of crop stalks and the spacing therebetween can be recorded in a geographically referenced manner. Linking the data on the diameter and the number of crop stalks and the spacing between the crop stalks to the respective position of the measurement makes it possible to perform an evaluation at a later point in time. The diameters of the crop stalks are mapped, for example, which is used as an additional indicator for the fertilization process after new sowing is carried out. This information also can be evaluated for statistical purposes, of course, in order to create a histogram of the stalk diameter, for example.

Preferably, the diameter value of a crop stalk is determined from the duration of a signal change and the actual ground speed of a carrier vehicle carrying the snapping unit. To this end, a control unit is provided on the carrier vehicle that comprises a processor unit and a memory unit for the storage of the data and algorithms that can be processed by the processor unit.

In an embodiment, the invention provides a snapping unit having stripper plates disposed in pairs and configured to have variable spacing. A snapping gap is formed between the stripper plates in each case, which has an inlet region and a stripper region. The snapping unit also has means for drawing plant stalks into the snapping gap such that crop is severed from the crop stalks by the stripper plates. Preferably, the presence and the diameter of the crop stalks is determined before entry into the snapping gap by a sensor device disposed in front of the snapping gap and the width of the snapping gap is adjusted depending on the diameter value that is determined.

Advantageously, the sensor device embodies as a light barrier, for example, an arrangement of transmitter and receiver disposed separately from one another in front of the snapping gap. As an alternative, the light barrier can embody a reflex sensor, characterized by the placement of the transmitter and the receiver in a common housing. In this variant, the cabling complexity is reduced. It also is feasible to arrange the light barrier above sheet metal covers that cover the stripper plates and the means for drawing in the plant stalks.

Alternatively, the sensor device may embody a pair of sensing elements disposed in front of the respective snapping gap to be movable about an axis of rotation. As an alternative, the sensing elements can be linearly movable. The movement of the sensing elements induced by the stalks takes place substantially transversely to the snapping gap. The deflection of the sensing elements is detected by a potentiometer and a related signal is transmitted to the control unit for evaluation. This control unit evaluates the degree of deflection and the duration of the deflection, which, in combination with the ground speed, is used to deduce the diameter of the crop stalks. The deflection also is detected by linear sensors or angular sensors, depending on the embodiment of the sensing elements.

Preferably, at least two sensor devices are provided on the snapping unit, which are assigned at least to the respectively outermost stripper plates bordering a snapping gap. The assignment of one sensor device in each case to the outer snapping gaps of the snapping unit is a variant that is cost-effective yet can nevertheless yield relatively accurate results, since the signals of the respective sensor device disposed opposite thereto can be used as a reference. This can be significant when an initial cut is made into a field and the snapping unit does not enter the stand of crop along the entire width of the snapping unit. It is therefore possible to avoid inadvertently inferring that crop is absent.

The invention further relates to a combine harvester comprising a snapping device, as described herein.

### BRIEF DESCRIPTION OF THE DRAWINGS

Further features and advantages of the invention will become apparent from the description of embodiments that follows, with reference to the attached figures, wherein:

FIG. 1 shows a schematic view of a snapping device on a carrier vehicle;

FIG. 2 shows a sectional view of snapping rollers working together in pairs;

FIG. 3 shows a partial view of a snapping device constructed according to the invention, in a view from above;

FIG. 4 shows a schematic view of a row of crop stalks;

FIG. 5 shows a partial view of a snapping device in a view from above, according to a second embodiment; and

FIG. 6 shows a partial view of a snapping device 1 in a view from above, according to a third embodiment.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

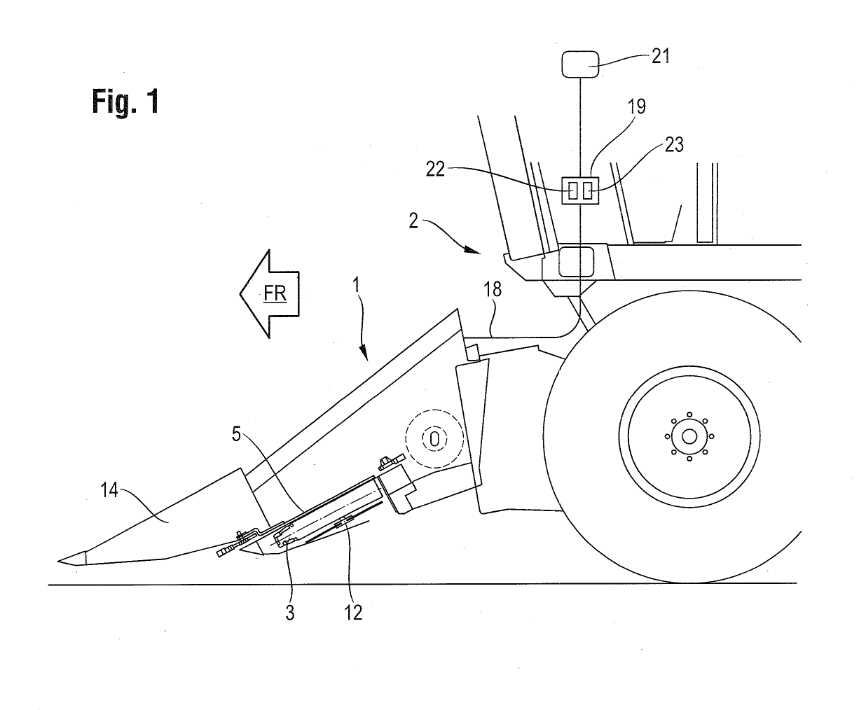

FIG. 1 shows a schematic depiction of a snapping device 1 for harvesting stalk crop that is mounted, in a rear region thereof, on a carrier vehicle 2 such as a combine harvester or a forage harvester. The snapping device 1, which operates in a row-dependent manner, simultaneously grasps a plurality of rows of stalk crop. A control unit 19 is disposed on the carrier vehicle 2, which is connected to the snapping device 1 by signal lines 18. The control unit 19 comprises a processor unit 22 and a memory unit 23 for the storage of data and algorithms for processing by the processor unit. A position detector 21 for determining the position of the carrier vehicle 2 in a satellite-supported manner is disposed on the roof of a driver's cab of the carrier vehicle 2; the position detector is connected to the control unit 19. An additional antenna for receiving correction signals also is provided on the roof of the driver's cab in order to increase the accuracy of the position determination.

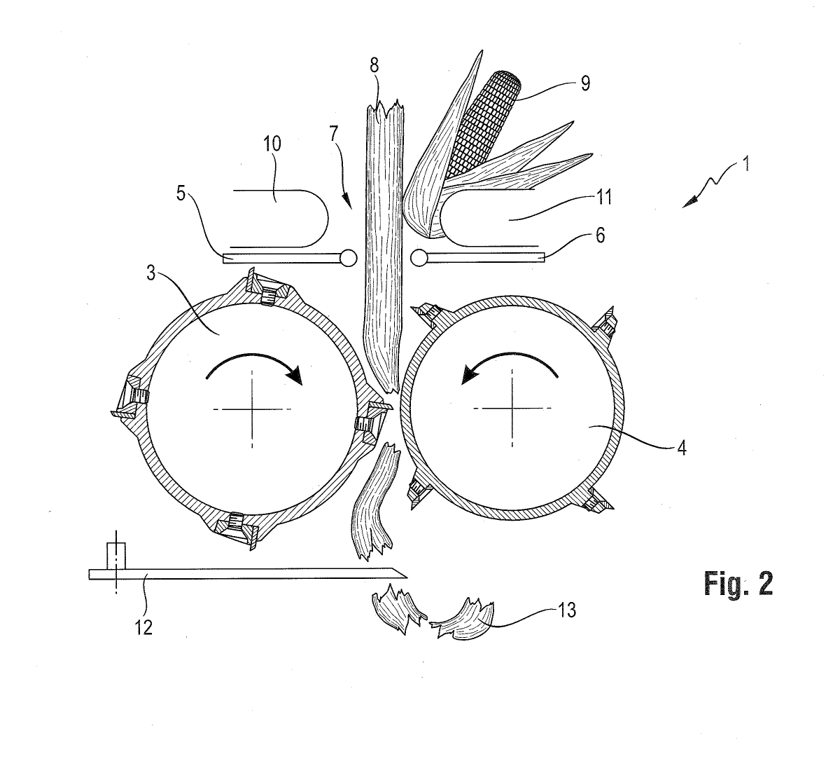

FIG. 2 shows a sectional view through the snapping device 1, which comprises a plurality of rows of oppositely driven snapping rollers 3, 4, which work together in pairs. A snapping gap 7 formed by displaceable stripper plates 5, 6 is assigned to the interacting snapping rollers 3, 4 on the top side, through which snapping gap the crop stalk 8 is drawn by the snapping rollers 3, 4. The snapping rollers 3, 4 are cylindrical or conical rollers comprising one component or several components.

Drawing the crop stalk 8 between the snapping rollers 3, 4 causes the respective crop stalk 8 to become deformed in a manner that permits rotting yet ensures that the shape of the stalk is retained. Crop 9 on the crop stalk 8 is stripped off on the stripper plates 5, 6 in the region of the snapping gap 7 and is transported in a manner known per se by conveyor chains 10, 11 disposed above the snapping gap 7 into the rear region of the snapping rollers 3, 4. The crop is transferred to non-illustrated working parts of the carrier vehicle 2. At least one chopping device 12 is assigned to the snapping rollers 3, 4 on the bottom side. The chopping device fragmentizes the crop stalks 8, which have already been mechanically processed by the snapping rollers 3, 4, and uniformly distributes the resultant chopped crop pieces 13 on the ground. Each row of the snapping unit 1 has a separate snapping gap 7, which is formed by the respective stripper plates 5, 6.

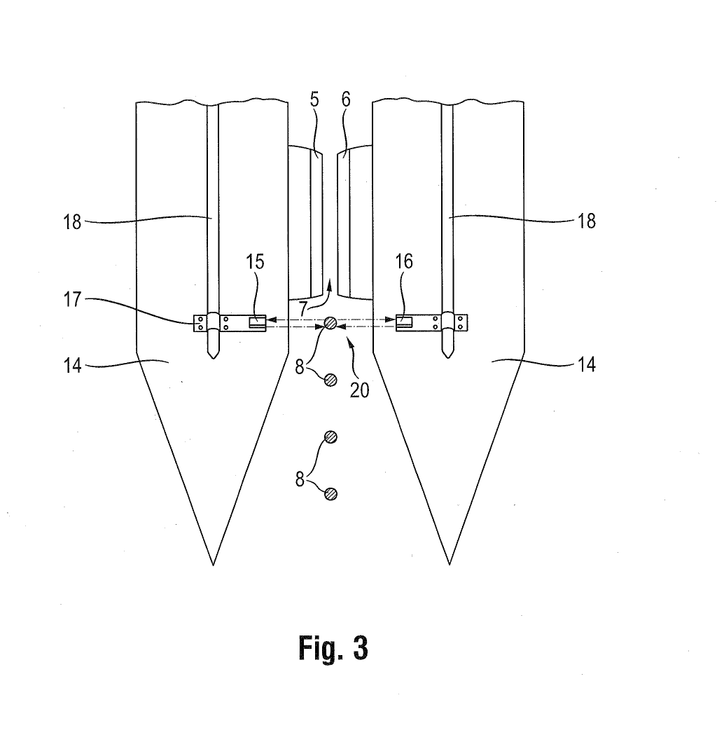

The representation in FIG. 3 shows a partial view of a snapping device 1 in a view from above. Shown therein is a pair of sheet metal covers 14, underneath which the snapping rollers 3, 4 and the conveyor chains 10, 11, which are covered by the sheet metal covers 14 and therefore not seen in FIG. 3, are disposed. The stripper plates 5, 6 also are evident, between which the snapping gap 7 forms. A light barrier 20, which functions according to the one-way principle, is disposed on the top side of each of the sheet metal covers 14. The light barrier 20 comprises a transmitter 15 in the form of a light source and a receiver 16. The transmitter 15 and the receiver 16 are disposed opposite one another, each one being mounted on a sheet metal cover by a holder 17. The holder 17 is used to orient the transmitter 15 and the receiver 16 of the light barrier 20 relative to one another and to hold these in this position.

Alternatively, reflex sensors also can be used, in the case of which the transmitter and the receiver are disposed parallel to one another in a common housing. The light emitted from the transmitter is reflected by the stalk crop 8 and is received by the receiver in the same housing. A reflector, which reflects the light, also can be mounted opposite the reflex sensor. If a crop stalk 8 is located in the beam path, no light, or at least much less light, enters the detector of the reflex sensor, which switches to “dark”. In this variant, the reflex sensor and the associated reflector also can be disposed in a position deviating from a 90° angle with respect to the direction of travel. It also is feasible to arrange the light barrier 20 in the interior of the sheet metal covers 14. To this end, openings are provided in the mutually opposed side panels of the sheet metal covers 14, the openings closed by a transparent, wear-resistant material.

The transmitter 15 and the receiver 16 of the light barrier 20 are connected by a signal line 18 to the control unit 19, which is disposed on the carrier vehicle 2. The control unit 19 evaluates the signals transmitted by the light barrier 20 by an evaluation algorithm stored in the memory unit in order to detect the presence and the number of crop stalks 8 and the diameter thereof. The evaluation results are stored in a geographically referenced manner, which is made possible by the signals provided by the position detector 21. The diameter of a crop stalk 8 is calculated from the duration of the interruption of the light barrier 20 and the current ground speed of the carrier vehicle 2.

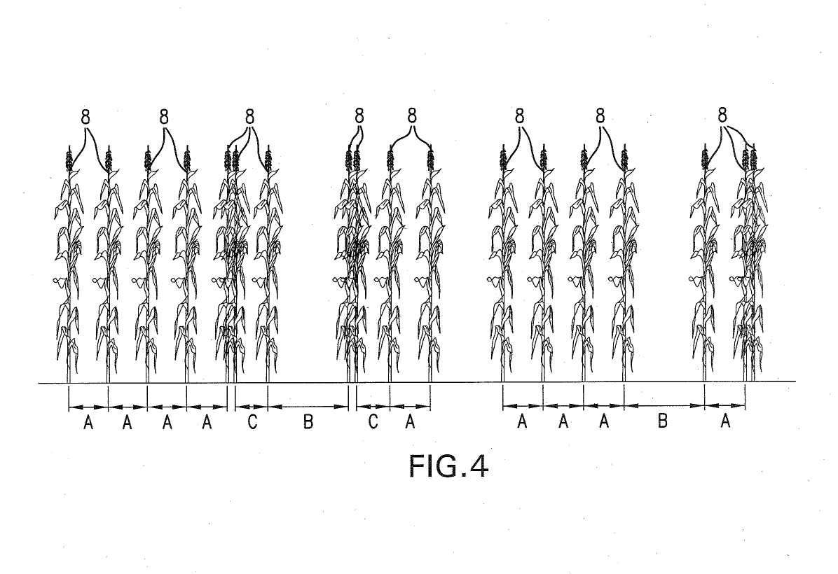

What is detected is the number of separate crop stalks 8 in a row and doubled crop stalks 8, i.e., two crop stalks 8 that have grown directly next to one another, or the complete absence of a crop stalk 8 at a point at which a crop stalk is expected on the basis of a spacing A selected during sowing, as depicted in FIG. 4. That is, FIG. 4 shows a schematic view of a row of crop stalks 8 that would have virtually the same spacing A relative to one another under optimal sowing conditions. If a grain of seed corn was not planted during sowing, a gap results, thereby resulting in the formation of a spacing B between two crop stalks, which approximately corresponds to twice the value of the spacing A.

In contrast, if two grains of seed corn are planted next to one another, two crop stalks 8 grow directly next to one another, which is also indicated in the representation in FIG. 4. A spacing C to the next crop stalk 8 can be correspondingly less than the spacing A predefined with the sowing. The respective position signal provided by the position detector 21 is used during the detection in order to link the position signal to the respectively detected value of the diameter and number and to the spacing between the individual crop stalks 8. The result of the application of fertilizer can be inferred from the geographical referencing, in order to improve the process of the application of fertilizer in a subsequent sowing. Doing so realizes a greater consistency in the crop growth.

In addition, the signal representing the diameter is used to more flexibly adapt the width of the snapping gap 7 to the diameter of the crop stalks 8. An objective of this operation is to avoid severing not only crop but also material from the crop stalk, which could occur if the width of the snapping gap 7 is too small. A width of the snapping gap 27 that is too great also is disadvantageous, since parts of the crop can then enter the region between the snapping rollers 3, 4, which results in crop losses. The arrangement of the light barrier 20 in front of the snapping gap 7 makes it possible to extend the reaction time between the instant in which the diameter of the crop stalk 8 is determined and the arrival thereof at the snapping gap 7. The width of the snapping gap is automatically adjusted via the activation of actuators for displacing the stripper plates 5, 6 by the control unit 19 depending on the diameter values that were determined.

A further aspect is the arrangement of at least two light barriers 20 on the sheet metal covers 14, each of which is assigned at least to the outermost stripper plate 5, 6 bordering the snapping gap 7. When an initial cut is made into a field it is thereby ensured that crop stalks 8 are fed to at least one snapping gap 7 monitored by a light barrier 20, wherein the number and diameter of crop stalks is determined. If the snapping device 1 is located entirely in the crop stand, the second arrangement on the opposite side of the snapping device 1 is used as a reference. By use of the values for the diameter and the presence of crop stalks 8 detected at the two measurement points, it is possible to perform a statistical evaluation and infer the composition of the rows of crop stalks 8 located between the measurement points. A suitable algorithm for the statistical evaluation is stored in the control unit 19. The arrangement of only two light barriers 20 on the snapping device 1 is a cost-effective alternative.

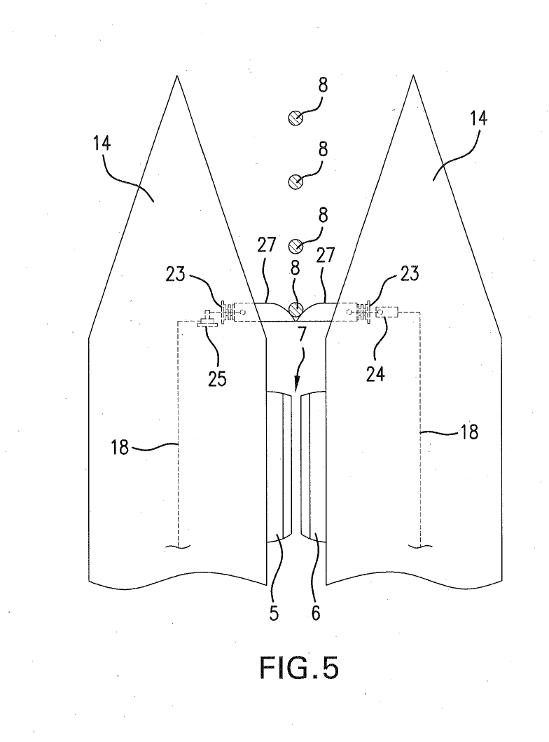

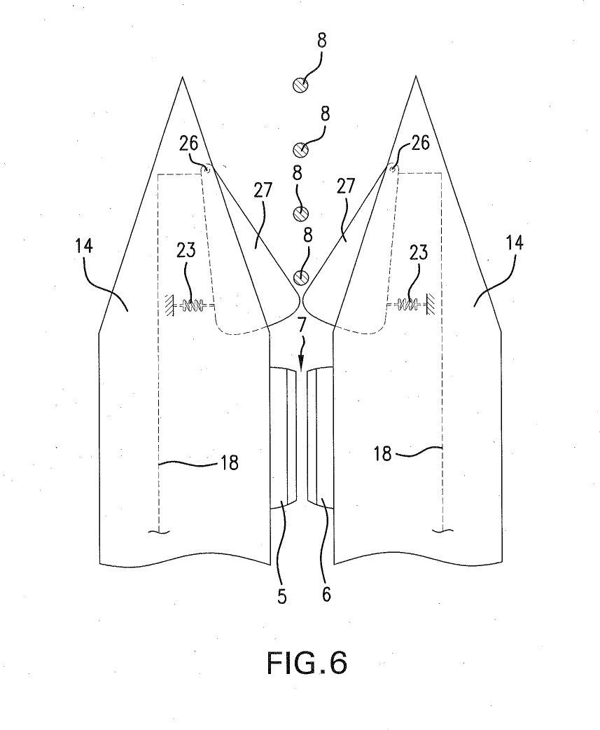

Alternative embodiments of the invention are shown in FIGS. 5 and 6. FIG. 5 shows a design having mechanical sensing elements 27, which are disposed in pairs in front of the snapping gap 7. The sensing elements 27 are linearly deflected by the respective stalks 8. A spring element 23 is assigned to the respective sensing element 27 and exerts a restoring force on the respective sensing element 27 in order to return the sensing element 27 after the respective stalk 8 has passed. The deflection of the sensing elements 27 is detected by a pair of linear sensors 24 (only one of which being depicted on the right side of FIG. 5, for exemplary purposes) or a pair of potentiometers 25 (only one of which being depicted on the left side of FIG. 5, for exemplary purposes), which are assigned to the sheet metal covers 14 in a stationary manner. A signal representing the deflection is transmitted via the signal line 18 to the control unit 19 for evaluation. The respective spring element 23 bears against a holder, which accommodates the respective sensor 24 or 25, and the sensing element 27.

FIG. 6 shows an embodiment in which the mechanical sensing elements 27 are mounted in an articulated manner so as to permit swivelling, relative to the sheet metal cover 14, about a vertical axis 26 disposed in the region of the tip of the sheet metal cover 14 of the snapping device 1. The vertical axis 26 is connected to an angular sensor, which detects the rotational movement induced by the deflection of the sensing elements 27 by the respective stalks 8. In this embodiment, the sensing elements 27 extend from a region at the tip of the sheet metal cover 14 in the direction of the snapping gap 7. As described above, the sensing elements 27 in this embodiment also are acted upon by spring elements 23 with a restoring force in order to return said sensing elements into the starting or neutral position thereof after a stalk 8 has passed.

### LIST OF REFERENCE SIGNS

| | |
|---|---|
| 1 | snapping device |
| 2 | carrier vehicle |
| 3 | snapping roller |
| 4 | snapping roller |
| 5 | stripper plate |
| 6 | stripper plate |
| 7 | snapping gap |
| 8 | crop stalk |
| 9 | crop |
| 10 | conveyor chain |
| 11 | conveyor chain |
| 12 | chopping device |
| 13 | chopped crop pieces |
| 14 | sheet metal cover |
| 15 | transmitter |
| 16 | receiver |
| 17 | holder |
| 18 | signal line |
| 19 | control unit |
| 20 | light barrier |
| 21 | position detector |
| 22 | processor unit |
| 23 | spring element |
| 24 | linear sensor |
| 25 | potentiometer |
| 26 | angular sensor |
| 27 | guide element |
| A | spacing |
| B | spacing |
| C | spacing |
| FR | direction of travel |

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method for operating a snapping device for harvesting stalk crop, the snapping device including stripper plates disposed in pairs and arranged with variable spacing therebetween to form of a snapping gap and a sensor device disposed in from of the snapping gap, the method comprising:
using the sensor device, determining a diameter of crop stalks before the crop stalks are drawn into the snapping gap;
adjusting a width of the snapping gap depending on the determined diameter of the crop stalks;
drawing the crop stalks into the adjusted snapping gap; and
severing the plant stalks by the stripper plates.

2. The method according to claim 1, wherein the diameter of the crop stalks is contactlessly determining by the sensor device.

3. The method according to claim 2, wherein the diameter of the crop stalks is contactlessly determining by a capacitance-based measurement method.

4. The method according to claim 2, wherein the diameter of the crop stalks is contactlessly determining by an optically-based measurement method.

5. The method according to claim 1, wherein the the diameter of the crop stalks are determining by mechanical sensing elements.

6. The method according to claim 1, wherein the snapping-gap width is automatically varied.

7. The method according to claim 1, wherein a number of crop stalks and a spacing (A, B, C) therebetween are detected.

8. The method according to claim 1, wherein the detected diameter, a number of crop stalks and a spacing (A, B, C) therebetween are recorded in a geographically referenced manner.

9. The method according to claim 1, wherein the diameter of the crop stalks is determining based on a duration of a signal change and a current ground speed of a carrier vehicle carrying the snapping unit.

10. A snapping device for harvesting stalk crop, comprising:
stripper plates arranged in pairs with a variable spacing between the stripper plates forming a snapping gap having an inlet region and a stripper region;
means for drawing plant stalks into the snapping gap so that crop fruits are severed from crop stalks by the stripper plates; and
a sensor device disposed in front of the snapping gap for determining a diameter of the crop stalks before entry into the snapping gap;
wherein a width of the snapping gap is adjusted depending on the determined diameter of the crop stalks.

11. The snapping device according to claim 10, wherein the sensor device is embodied as a light barrier.

12. The snapping device according to claim 10, wherein the sensor device is embodied as a pair of sensing elements.

13. The snapping device according to claim 10, wherein at least two sensor devices are provided on the snapping unit and wherein one of the two snapping devices is assigned to a respectively outermost stripper plate bordering the snapping gap.

14. A combine harvester comprising a snapping device, the snapping device comprising:
stripper plates arranged in pairs with a variable spacing between the stripper plates forming a snapping gap having an inlet region and a stripper region;
means for drawing plant stalks into the snapping gap so that crop fruits are severed from crop stalks by the stripper plates; and
a sensor device disposed in front of the snapping gap for determining a diameter of the crop stalks before entry into the snapping gap;
wherein a width of the snapping gap is adjusted depending on the determined diameter of the crop stalks.
